(19) United States
(12) Patent Application Publication
(10) Pub. No.: US 2009/0128495 A1
(43) Pub. Date: May 21, 2009

(54) OPTICAL INPUT DEVICE

(75) Inventors: Yuan Kong, Kirkland, WA (US); Jianping Xie, Hefei (CN); Hai Ming, Hefei (CN); Hongbo Wang, Hefei (CN); Huaqiao Gui, Hefei (CN); Tianpeng Zhao, Hefei (CN); Jun Xu, Hefei (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/942,739

(22) Filed: Nov. 20, 2007

(51) Int. Cl. G06F 3/02; G01J 1/04

(52) U.S. Cl. 345/170; 250/227.16

(57) ABSTRACT

An input device includes an optical waveguide, one or more light sources, one or more imaging sensors, and a translator. The optical waveguide has an input surface, a back surface substantially opposite the input surface, and a side surface therebetween. The input surface has a plurality of different input locations. The one or more light sources are positioned to introduce light into the optical waveguide. A distortion of each different input location of the input surface causes a portion of light within the optical waveguide to exit from the optical waveguide at a different escape location of the side surface. The one or more imaging sensors are positioned and aimed to detect an escape location of a portion of light exiting from the side surface. The translator determines an input location corresponding to the escape location for each detected escape location.

### BACKGROUND

Keyboards serve as input devices for computers and other devices. Keyboards can be designed with a plurality of keys, each of which can correspond to one or more letters, numbers, commands, or other forms of input. The number and arrangement of keys, as well as the types of input associated with such keys, can be selected based on a desired use for a particular keyboard. Some keyboards may also include scroll wheels, track pads, trackballs, or other complementary input devices capable of providing different types of input.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An input device is provided. The input device includes an optical waveguide into which light is introduced. The optical waveguide is configured so that some of the light that is introduced into the optical waveguide exits from a side of the optical waveguide responsive to a local distortion of an input surface of the optical waveguide. The escape location from which the light exits corresponds to the location of the local distortion of the input surface. The side of the optical waveguide is optically monitored to detect the escape location of light leaving the side of the optical waveguide. A translator uses the detected escape location to determine the distorted location on the input surface.

### BRIEF DESCRIPTION OF THE DRAWINGS

FIG. 1 shows an input device according to an embodiment of the present disclosure.

FIG. 2 shows a nonlimiting example of an aperture on a side surface of an optical waveguide.

FIG. 3 shows a nonlimiting example of an aperture on a side surface of an optical waveguide.

FIG. 4 shows light reflecting within an optical waveguide.

FIG. 5 shows light exiting from an escape location of a side surface of an optical waveguide responsive to a key being pressed to cause a localized distortion of an input location of an input surface of the optical waveguide.

FIG. 6 shows light exiting from a different escape location responsive to a different input location being distorted.

FIG. 7 shows light exiting from two different escape locations responsive to two different input locations being distorted.

FIG. 8 shows an optical waveguide having an elastic input surface.

FIG. 9 shows an optical waveguide having a layer of elastic material that matches the index of refraction of the optical waveguide.

FIG. 10 shows a key having a layer of elastic material that matches the index of refraction of the optical waveguide.

FIG. 11 somewhat schematically shows a plurality of different keys, each having an identifiable contacting shape.

FIG. 12 shows a cross-sectional view of a two-stage input key in an inactivated state.

FIG. 13 shows the two-stage input key of FIG. 12 in an activated state.

FIG. 14 shows an input device according to an embodiment of the present disclosure.

FIG. 15 shows a process flow for executing a method of receiving input according to an embodiment of the present disclosure.

### DETAILED DESCRIPTION

The present disclosure is directed to an optical input device. The input device utilizes an optical waveguide as an input surface. The optical waveguide is configured to allow light to exit from a side surface of the optical waveguide in response to the input surface being locally distorted. Such local distortion can result from a user pressing the input surface, either directly with the user's finger, or indirectly with an object such as a button, key, or stylus. The location that light exits from the side of the optical waveguide is geometrically predictable based on the location at which the input surface is locally distorted. In other words, the escape location directly corresponds to the distortion location on the input surface. Therefore, user input on the input surface can be monitored by viewing the location from which light exits the side of the optical waveguide.

As used herein, the term distortion may be used to refer to physical deformations of an input surface, an optical layer applied to an input surface, and/or a portion of an object touching the input surface. However, such physical deformation is not necessarily required in all embodiments. Distortions can result from any condition that changes the total internal reflection characteristics of the optical waveguide. As a nonlimiting example, an optical coupling of an object to the input surface of the optical waveguide can cause a distortion without physically deforming the input surface. As such, the term distortion should be interpreted to include any condition that changes the total internal reflection characteristics of the optical waveguide.

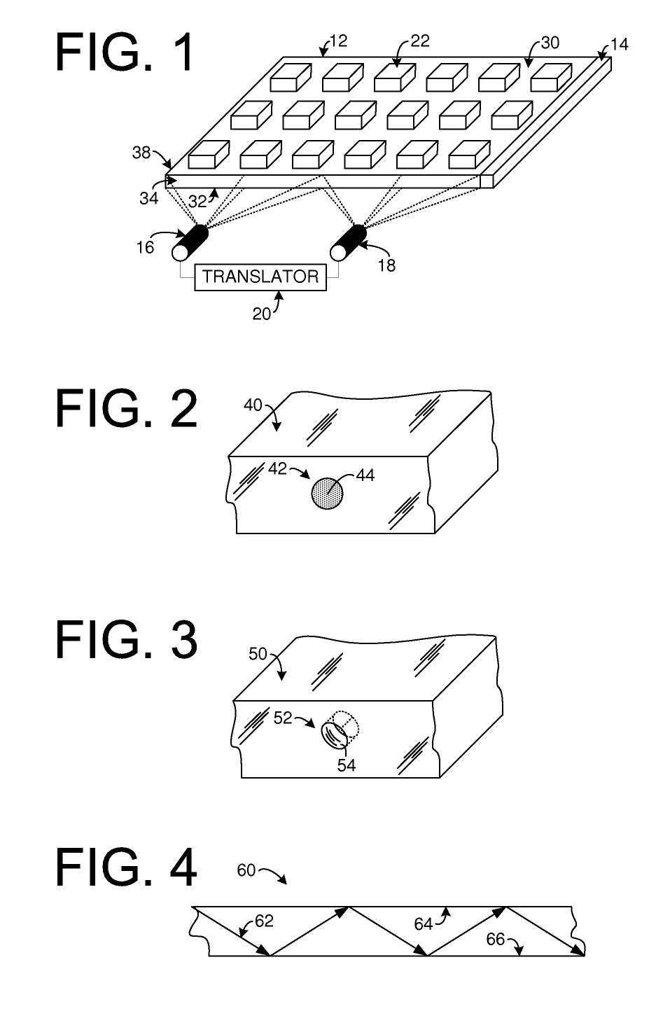

FIG. 1 somewhat schematically shows an example input device 10 according to the present disclosure. Input device 10 includes an optical waveguide 12, a light source 14, imaging sensor 16 and imaging sensor 18, a translator 20, and one or more keys, such as key 22. While the present disclosure uses a keyboard as an exemplary input device, input devices other than keyboards are within the scope of the present disclosure.

Optical waveguide 12 includes an input surface 30, a back surface 32 substantially opposite the input surface, and a side surface 34 therebetween. The shape of the optical waveguide determines how many side surfaces are present. For example, a rectangular optical waveguide, as illustrated, includes four side surfaces. A triangular optical waveguide includes three side surfaces. A circular optical waveguide includes a single side surface that extends all the way around a perimeter of the optical waveguide.

The illustrated optical waveguide is a substantially homogeneous slab of light-transmitting material. The light-transmitting material can be glass, plastic, or another suitable material. In some embodiments, the optical waveguide can include one or more surfaces that are coated with a reflective layer and/or polished. Such treatments can increase the ability of the optical waveguide to keep light that is introduced into the optical waveguide trapped within the optical waveguide. A reflecting mirror may also be positioned adjacent one or more surfaces to limit light from exiting from those surfaces.

The optical waveguide can include one or more apertures that allow light into the optical waveguide from one or more light sources. As shown in FIG. 2, an optical waveguide 40 may include an aperture 42. Aperture 42 may include a window 44 with an absence of a reflective coating and/or polishing that allows light to pass into the optical waveguide with less obstruction. As shown in FIG. 3, an optical waveguide 50 may include an aperture 52. Aperture 52 may include a tunnel 54 that is coated with a reflective layer and/or polished to help concentrate light within the optical waveguide. In some embodiments, an aperture can be substantially continuous with the surrounding surface and include substantially the same coatings or treatments, or lack thereof, as the surrounding surface.

As shown in FIG. 4, once introduced to the optical waveguide 60, light 62 may reflect off of an inside face of an input surface 64, back surface 66, and/or one or more side surfaces (not shown). Such reflection can result from total internal reflection, reflection off of a polished surface, reflection off of a surface coated with a reflective layer, and/or reflection off of an adjacent reflecting mirror.

An optical waveguide can be a variety of different sizes and shapes without departing from the scope of the present disclosure. As a nonlimiting example, the optical waveguide may be a 350 millimeter wide by 180 millimeter deep by 10 millimeter tall cuboid. In some embodiments, a side surface may be skewed so as to provide a more favorable viewing angle for an imaging sensor.

Turning back to FIG. 1, light source 14 may be positioned to introduce light into the optical waveguide. One or more individual lights can collectively constitute light source 14, or light source 14 may include a single light. For example, light source 14 may include an array of light emitting diodes, a single light emitting diode, and/or one or more different types of lights. In some embodiments, the light source may introduce visible light into the optical waveguide. In some embodiments, the light source may introduce infrared light, or another form of electromagnetic radiation, into the optical waveguide.

A light source can be positioned to introduce light into the optical waveguide from one or more sides of the optical waveguide. As a nonlimiting example, FIG. 1 shows light source 14 introducing light into a single side surface of the optical waveguide. In other embodiments, light can be introduced from two or more sides, the input surface, and/or the bottom surface. As described above, the optical waveguide may include one or more apertures to facilitate the introduction of light into the optical waveguide.

The distribution of individual lights relative to the optical waveguide can be selected to produce a desirable light concentration within the optical waveguide. For example, in an embodiment that utilizes a light source including an array of light emitting diodes, the individual light emitting diodes can be positioned closer together near one end of the array. In that way, that end of the array can introduce relatively more light into the optical waveguide.

Distortion of input surface 30 may cause light to exit from side surface 34 in a geometrically predictable manner. In other words, the location from which light exits the side surface can serve as an indicator as to where the input surface is locally distorted. Light exiting from the side surface can cause a bright spot having a shape and/or other escape characteristic that results from the distortion at the input surface. The shape and/or other escape characteristic can be used, in addition to the location of the bright spot, as an indicator as to what type of localized distortion was caused by an input event.

The input surface may be conceptually divided into a plurality of different input locations, each of which corresponds to a different escape location on the side surface. Light may exit from each escape location when its corresponding input location is locally distorted. The input surface may include a discrete number of different input locations, or the input surface may alternatively include a substantially infinite number of different input locations distributed substantially continuously over the input surface.

The correspondence between localized distortions of the input surface and geometrically predictable escape locations on the side surface may at least partially result from frustrated total internal reflection of light within the optical waveguide. In other words, a localized distortion of the input surface can frustrate total internal reflection, thus causing light to exit from the side surface of the optical waveguide at an escape location determined by the localized area of distortion on the input surface.

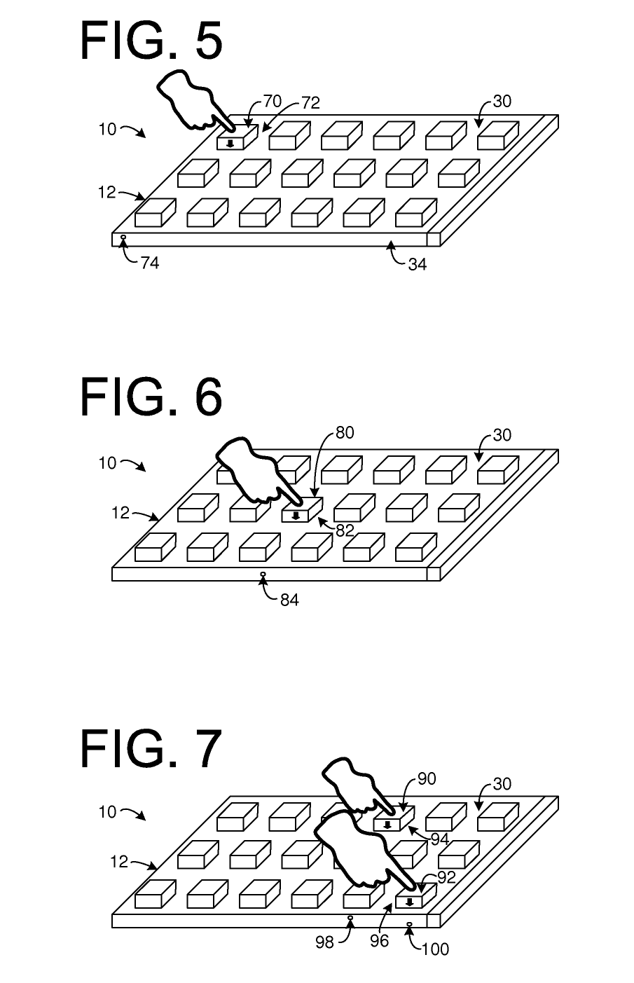

FIGS. 5, 6, and 7 somewhat schematically show the geometric predictability of escape locations relative to locally distorted input locations. FIG. 5 shows a key 70 being pressed to distort an input location 72 of input surface 30. Responsive to the localized distortion, light exits from side surface 34 of optical waveguide 12. In particular, light exits from an escape location 74 that corresponds to input location 72 in a geometrically predictable manner.

FIG. 6 shows a key 80 being pressed to distort an input location 82 of input surface 30. Responsive to the localized distortion, light exits from input location 84 in a geometrically predictable manner.

As can be seen by comparing FIG. 5 and FIG. 6, the escape location changes depending on which key is pressed to distort the input surface. Because localized distortions at different input locations result in different escape locations, the escape locations serve as an indicator as to where the input surface is distorted.

Two or more localized distortions may be detectable based on the escape location or escape locations of light from the side surface. FIG. 7 shows a key 90 and another key 92 being pressed to distort both input location 94 and input location 96 of input surface 30. Responsive to the two different localized distortions, light exits from both input location 98 and input location 100 in a geometrically predictable manner.

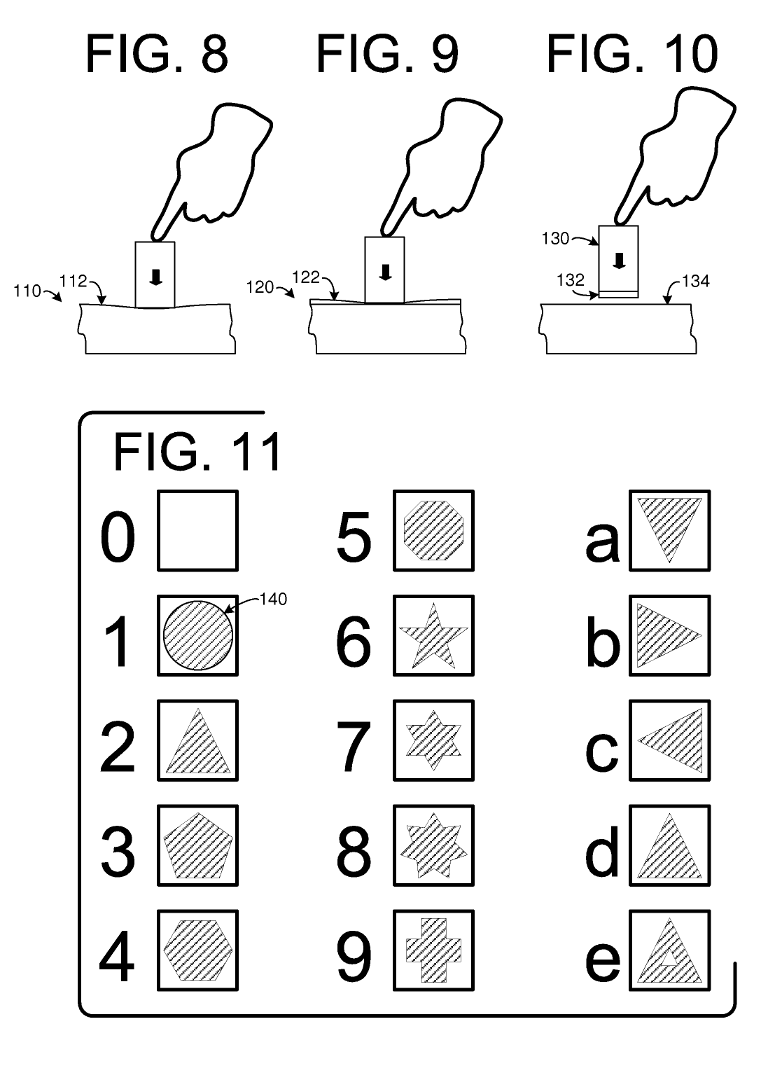

Localized distortions can be facilitated by one or more of the input surface and the object used to touch the input surface. For example, FIG. 8 shows an optical waveguide 110 and its input surface 112. In the illustrated embodiment, input surface 112 is elastic, although this is not required in all embodiments. When an object is touched and applied to input surface 112, the evanescent wave field of input surface 112 is disturbed and at least partially scattered. After the object is no longer applied to the input surface, the evanescent wave field of the input surface returns to its previously undisturbed state. Disturbed surface boundary condition can change the total internal reflection characteristics of the input surface.

As another example, FIG. 9 shows an optical waveguide 120 that includes an input surface that is coated with an elastic refractive-index-matching layer 122. Elastic refractive-index-matching layer 122 has substantially the same index of refraction as the optical waveguide, thus limiting refraction and/or other optical changes at the boundary between the optical waveguide and the refractive-index-matching layer. The refractive-index-matching layer is at least partially elastic in the illustrated embodiment. When an object is touched and applied to the refractive-index-matching layer, the refractive-index-matching layer at least partially deforms, thus changing the reflection condition and disturbing the evanescent wave field. After the force is no longer applied to the refractive-index-matching layer, the refractive-index-matching layer and the evanescent wave field return to the previously undeformed state. Silicone is a nonlimiting example of a material that can be used as a refractive-index-matching layer. In some embodiments, Silicone, or another material, can be treated so that the refractive index of the refractive-index-matching layer substantially matches the refractive index of the optical waveguide. Deformations to the refractive-index-matching layer can disrupt or otherwise change the total internal reflection characteristics of the input surface.

As still another example, FIG. 10 shows a key 130 that includes an elastic refractive-index-matching layer 132 configured to contact an input surface 134. When the key is pressed, the refractive-index-matching layer may deform as it is pressed against the input surface. This may disrupt or otherwise change the total internal reflecting characteristics of the input surface. When the key is released, refractive-index-matching layer 132 may return to its previously undeformed state.

An input device can include one or more keys, each key being configured to selectively distort a different input location of the input surface. In some embodiments, one or more of the keys may have a different contacting shape for distorting the input surface than another one or more of keys. In other words, the physical shape of the portion of the key that contacts the input surface may differ from one key to the next. The different contacting shapes can cause light to exit from the side surface in different identifiable patterns. The pattern of light exiting can be used to identify which key was used to cause a distortion to the input surface. This can be useful in embodiments where the keys can be selectively repositioned on the input surface, because the key can be identified even if it does not always contact the same input location.

For example. FIG. 11 somewhat schematically shows a plurality of different contacting shapes, such as contacting shape 140. Each different contacting shape can correspond to a different input. FIG. 11 shows each contacting shape next to a nonlimiting example of a character with which the contacting shape can be associated. For example, contacting shape 140, in the form of a circle, can be associated with the “1” character. In this manner, any distortion that is caused by a key having a circular contacting shape can be attributed to entry of a “1” character. The shape, size, orientation, and other attributes of a contacting shape can be used to distinguish one contacting shape from another.

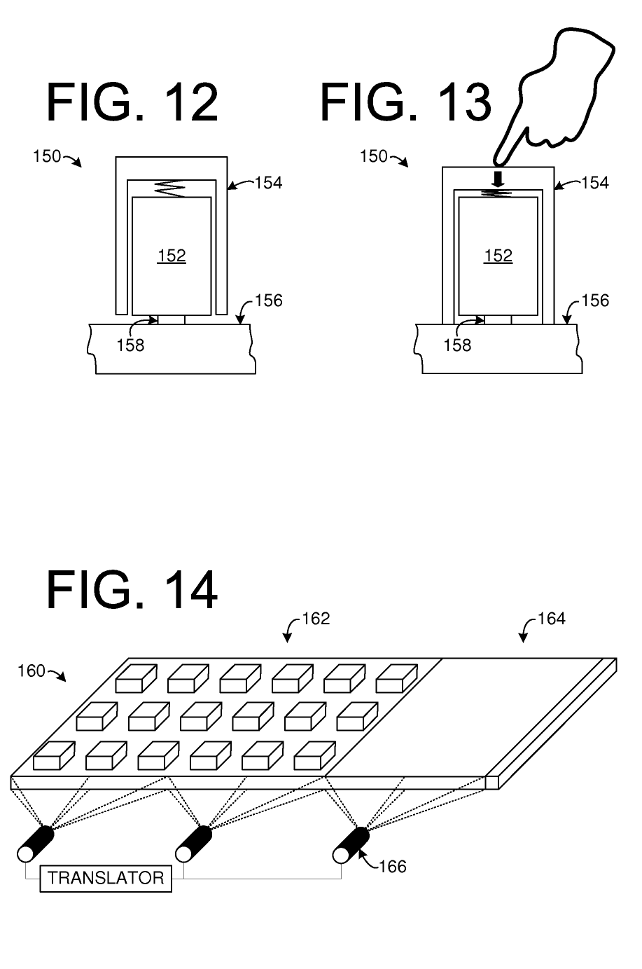

A button, key, or other input device optionally can be configured as a two-stage device. For example, FIGS. 12 and 13 somewhat schematically shows a side cross-sectional view of a nonlimiting example of a two-stage input key 150. Two-stage input key 150 includes a static member 152 and a dynamic member 154. The static member can remain in contact with input surface 156, while the dynamic member is in selective contact with the input surface. For example, FIG. 12 shows two-stage input key 150 in an inactivated state in which dynamic member 154 is not contacting input surface 156, while FIG. 13 shows two-stage input key 150 in an activated state in which dynamic member 154 is contacting input surface 156.

The static member can include an identifiable contacting shape 158. The static member of one or more keys can have a different contacting shape than the static member of one or more other keys. In this manner, the different keys can be identified from one another, even before the keys are activated. This allows keys to be rearranged and/or repositioned on the input surface. A two-stage input key can be activated by causing the dynamic member to come into contact with the input surface, which can change the profile of light exiting the side surface. In this way, the static portion can be used to identify the key, and the dynamic portion can be used to identify when the key is activated.

An input device according to the present disclosure can include a positioning assembly that holds one or more keys in position to selectively distort the input surface of the optical waveguide. In some embodiments, the positioning assembly allows the keys to be rearranged.

Turning back to FIG. 1, input device 10 may include one or more imaging sensors, such as imaging sensor 16 and imaging sensor 18, which are positioned and aimed to detect an escape location of a portion of light exiting from the side surface. The imaging sensors monitor the escape profile of light exiting the side surface so that any changes to the escape profile can be used to discern how the input surface was distorted to cause such changes. The imaging sensors may be used to detect the locations from which light is exiting, and such information can be used to identify the locations and/or shapes of the distortions at the input locations corresponding to the escape locations.

The imaging sensors are configured to convert the escape profile of light exiting side surface 34 into an electrical signal. The imaging sensors may include complementary metal-oxide-semiconductors (CMOS), charge-coupled devices (CCD), or other suitable devices for converting light information into electrical signals.

The imaging sensors may optionally include one or more lenses, mirrors, or other optical devices for collecting, aiming, focusing, or otherwise modifying light after it leaves the optical waveguide.

An imaging sensor may be configured with a relatively wide viewing angle or a relatively narrow viewing angle, depending on the optics and intended placement for that imaging sensor. As a nonlimiting example, a CMOS sensor with a wide-angle collecting lens can be placed approximately 7 centimeters away from side surface 34, and approximately 3 centimeters away from an edge 38 of the side surface. The distance between the imaging sensor and the monitored side surface can be selected so as to improve the ability of the imaging sensor to accurately detect distortions to the input surface.

A distance that an imaging sensor is placed away from a side surface may be selected to limit the number of multiple reflections that the imagining sensor detects. For example, if placed too close to the side surface, the imaging sensor may detect multiple reflections attributable to the same distortion of the input surface. Detection of multiple reflections can be limited, if not eliminated, thus establishing a 1:1 correspondence between input distortions and detected bright spots on the side surface.

In some embodiments, two or more similarly configured imaging sensors can be used to monitor different portions of the side surface. In some embodiments, at least one of the imaging sensors may be different than another of the imaging sensors. For example, an imaging sensor with a relatively higher resolution may be used to monitor a portion of the side surface that corresponds to a fingerprinting location on the input surface, while an imaging sensor with a relatively lower resolution may be used to monitor a portion of the side surface that corresponds to a keyboard location on the input surface.

For example, FIG. 14 somewhat schematically shows an input device 160 that includes a keyboard portion 162 and an auxiliary input portion 164. The auxiliary input portion can be used to enter input other than key strokes. For example, a user may use the auxiliary input portion as a track pad, drawing tablet, fingerprint recognition area, etc. As described above, distortions to the auxiliary input portion of an input surface can be identified by monitoring light output of the side surface of the optical waveguide. As shown in FIG. 14, an input device may include a dedicated imaging sensor 166 that is used to monitor the portion of the side surface that corresponds to the auxiliary input portion. In other embodiments, one or more imaging sensors can be used to monitor both a keyboard portion and an auxiliary input portion of the optical waveguide.

In some keyboard applications, the imaging sensors can be located in a wrist rest area of the keyboard. This allows the imaging sensors to be spaced an advantageous distance from the optical waveguide, while at the same time maintaining a desirable keyboard form factor.

Turning back to FIG. 1, input device 10 also includes a translator 20, which is configured to determine an input location corresponding to the escape location for each detected escape location. In other words, the translator receives information about the escape profile of light exiting the side surface from the imaging sensors and uses the information to identify what distortions were made to the input surface. The translator may include virtually any hardware, software, firmware, or combination thereof, that is capable of performing logical operations. The translator may include a lookup table that matches different escape locations to corresponding input locations. As such, when light is detected leaving an escape location, the lookup table can be used to determine the input location at which distortions cause light to exit that escape location.

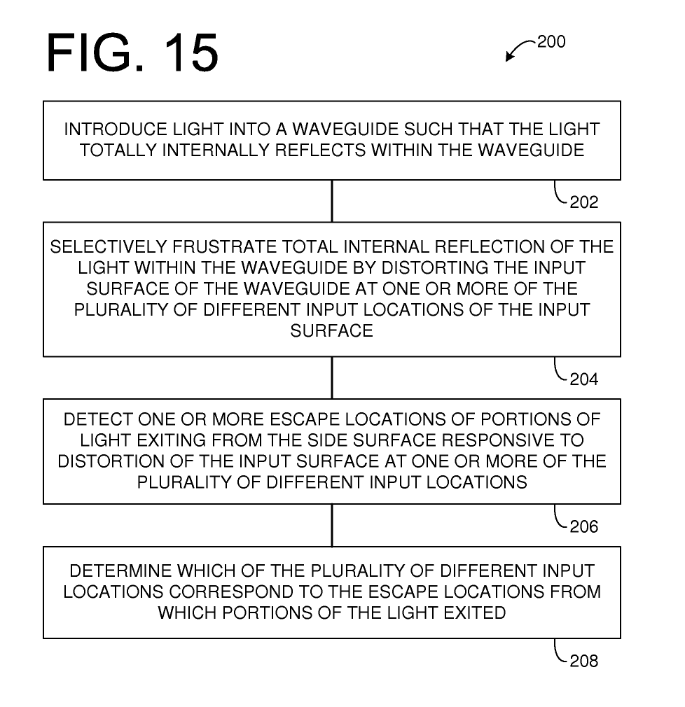

FIG. 15 shows a process flow for executing a method 200 of receiving input according to the present disclosure. At 202, the method includes introducing light into a waveguide such that the light totally internally reflects within the waveguide. This can be performed with a waveguide that includes an input surface, a back surface substantially opposite the input surface, and a side surface therebetween, as described above. Also, as described above, the input surface may have a plurality of different input locations.

At 204, the method includes selectively frustrating total internal reflection of the light within the waveguide by distorting the input surface at one or more of the plurality of different input locations.

At 206, the method includes detecting one or more escape locations of portions of light exiting from the side surface responsive to distortion of the input surface at one or more of the plurality of different input locations.

At 208, the method includes determining which of the plurality of different input locations correspond to the escape locations from which portions of the light exited.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An input device, comprising:
an optical waveguide having an input surface, a back surface substantially opposite the input surface, and a side surface therebetween, the input surface having a plurality of different input locations;
one or more light sources positioned to introduce light into the optical waveguide, where a distortion of each different input location of the input surface causes a portion of light within the optical waveguide to exit from the optical waveguide at a different escape location of the side surface;
one or more imaging sensors positioned and aimed to detect an escape location of a portion of light exiting from the side surface; and
a translator to determine an input location corresponding to the escape location for each detected escape location.

2. The input device of claim 1, further comprising one or more keys, each key being configured to selectively distort a different input location of the input surface.

3. The input device of claim 2, where one or more of the keys have a different contacting shape for distorting the input surface than another one or more of the keys.

4. The input device of claim 2, where one or more of the keys includes a static member in contact with the input surface and a dynamic member in selective contact with the input surface.

5. The input device of claim 4, where one or more static members have a different contact shape for distorting the input surface than another one or more static members.

6. The input device of claim 2, where each key includes an elastic refractive-index-matching layer for contacting the input surface.

7. The input device of claim 1, where the input surface of the optical waveguide is elastic.

8. The input device of claim 1, where the input surface of the optical waveguide is coated with an elastic refractive-index-matching layer.

9. The input device of claim 1, where one or more of the one or more imaging sensors is configured to identify a shape of the distortion at the input location corresponding to one or more escape locations.

10. The input device of claim 1, where a surface of the optical waveguide is coated with a reflective material.

11. The input device of claim 1, where a surface of the optical waveguide is polished.

12. The input device of claim 1, where the optical waveguide includes an aperture configured to allow light into the optical waveguide from one or more of the one or more light sources.

13. The input device of claim 12, where the aperture is coated with a reflective layer configured to concentrate light within the optical waveguide.

14. The input device of claim 1, where the optical waveguide includes an auxiliary input portion for receiving track pad input.

15. The input device of claim 1, where the optical waveguide includes an auxiliary input portion for receiving fingerprint input.

16. A keyboard, comprising:
an optical waveguide having an input surface, a back surface substantially opposite the input surface, and a side surface therebetween, the input surface having a plurality of different input locations;
one or more light sources positioned to introduce light into the optical waveguide, where a distortion of each different input location of the input surface causes a portion of light within the optical waveguide to exit from the optical waveguide at a different escape location of the side surface;
one or more imaging sensors positioned and aimed to detect an escape location of a portion of light exiting from the side surface;
one or more keys, each key being configured to selectively distort a different input location of the input surface; and
a translator to determine an input location corresponding to the escape location for each detected escape location.

17. The keyboard of claim 16, where one or more of the keys have a different contacting shape for distorting the input surface than another one or more of the keys.

18. The keyboard of claim 16, where one or more of the keys includes a static member in contact with the input surface and a dynamic member in selective contact with the input surface.

19. The keyboard of claim 18, where one or more static members have a different contact shape for distorting the input surface than another one or more static members.

20. A method of receiving user input, comprising:
introducing light into a waveguide such that the light totally internally reflects within the waveguide, where the waveguide includes an input surface, a back surface substantially opposite the input surface, and a side surface therebetween, the input surface having a plurality of different input locations;
selectively frustrating total internal reflection of the light within the waveguide by distorting the input surface at one or more of the plurality of different input locations;
detecting one or more escape locations of portions of light exiting from the side surface responsive to distortion of the input surface at one or more of the plurality of different input locations;
determining which of the plurality of different input locations correspond to the escape locations from which portions of the light exited.
